(19) United States
(12) Patent Application Publication
(10) Pub. No.: US 2008/0309484 A1
(43) Pub. Date: Dec. 18, 2008

(54) Detecting Explosive Mixture Based On Identifying Components of Explosive Mixture Using Molecular Computational Identification

(75) Inventors: Arthur R. Francis, Raleigh, NC (US); Ruthie D. Lyle, Durham, NC (US); Veronique Le Shan Tice Moses, Raleigh, NC (US); Denny Pichardo, Raleigh, NC (US)

Correspondence Address: IBM CORP. (WSM);c/o WINSTEAD SECHREST & MINICK P.C., P.O. BOX 50784, DALLAS, TX, 75201, US

(73) Assignee: International Business Machines Corporation, Armonk, NY (US)

(21) Appl. No.: 11/763,177

(22) Filed: Jun. 14, 2007

(51) Int. Cl. G08B 21/00; G08B 23/00

(52) U.S. Cl. 340/540; 340/573.1; 340/521

(57) ABSTRACT

A method, system and computer program product for detecting an explosive mixture. A potentially hazardous material is embedded with molecules where these molecules are used for identifying individual cells. Upon scanning the potentially hazardous material, the embedded molecules give off light or sonar signatures as output. The output of these molecules is read by a reader which is used to identify the type of material as well as the amount of the material. This information is stored and correlated with the passenger carrying the identified material and the passenger's flight information. A security alert is generated if there is a combination of amounts of potentially hazardous materials previously identified with the amount of potentially hazardous material currently identified that together would be classified as an explosive device where these potentially hazardous materials are to be carried by individual(s) on the same flight(s).

### TECHNICAL FIELD

The present invention relates to the field of security, and more particularly to detecting an explosive mixture based on identifying components of the explosive mixture using molecular computational identification.

### BACKGROUND INFORMATION

In the aftermath of the Sep. 11, 2001 attacks, there has been a renewed focus on providing security in public places, such as airports/airplanes, bridges, tunnels, schools, shopping malls, etc. In response to the Sep. 11, 2001 attacks, the United States government created the Department of Homeland Security with the responsibility of protecting the territory of the United States from terrorist attacks and responding to natural disasters.

On Aug. 10, 2006, authorities in the United Kingdom uncovered an alleged plot to sabotage as many as 10 U.S. airliners traveling from the United Kingdom to the United States, reportedly by using liquid and gel based explosives. The plotters had planned to use liquid explosives. The New York Times reported that the plotters planned to use Lucozade bottles to contain these explosives. The plotters planned to leave the top of the bottle sealed and filled with the original beverage, but add a false bottom containing a liquid or gel explosive dyed red to match the sports drink in the top of the container.

It has been widely reported that the plotters planned to use peroxide-based liquid explosives. United States authorities, the FBI and the Department of Homeland Security, named two peroxide-based liquid explosives that could be used: triacetone triperoxide (TATP) and hexamethylene triperoxide diamine (HMTD). These peroxide-based liquid explosives are sensitive to heat, shock, and friction, and can be initiated simply with fire or an electrical charge, and can also be used to produce improvised detonators.

Currently, the focus of preventing an explosive device from detonating at a public place, such as on an airplane, is focused on detecting banned materials (e.g., semtex) or on biometrics and facial scanning to identify a potential terrorist. However, as discussed above in connection with the United Kingdom terror plot, many of the hazardous materials were planned to be carried in common articles, such as liquids and gels. Further, the common articles, such as liquids and gels, may not be identified as an explosive device as a single component but may be used in combination to form an explosive device. Currently, there is no mechanism in detecting an explosive device based on identifying the combination of materials of the explosive device that may be carried in common articles.

Therefore, there is a need in the art for detecting an explosive mixture based on identifying components of the explosive mixture.

### SUMMARY

The problems outlined above may at least in part be solved in some embodiments by embedding molecules in potentially hazardous materials where these molecules are used for identifying individual cells or nano-devices. Upon scanning the potentially hazardous material, the embedded molecules act as tiny ID tags that use the presence of a chemical, or a mix of chemicals (e.g., potentially hazardous material), as inputs, and give off light or sonar signatures as output. The output of these molecules may be read by a reader which may be used to identify the type of material as well as the amount of the material. This information may be stored and correlated with the passenger carrying the identified material and the passenger's flight information. A security alert may be generated if there is a combination of other amounts of potentially hazardous materials previously identified along with the amount of potentially hazardous material currently identified that together would be classified as an explosive device where the amounts of potentially hazardous materials previously identified are being carried by individual(s) who are to board the same flight(s) as the passenger discussed above.

In one embodiment of the present invention, a method for detecting an explosive mixture comprises the step of scanning a potentially hazardous material embedded with molecules used for identifying individual cells, where the molecules generate one of light and sonar signatures based on the scanning. The method further comprises detecting either the light or sonar signatures generated based on the scanning. The method further comprises identifying an amount of the potentially hazardous material based on detecting either the light or sonar signatures. The method additionally comprises generating a security alert indicating existence of a potentially explosive mixture if there exists a combination of other amounts of potentially hazardous materials previously identified with the identified amount of the potentially hazardous material.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a system for detecting an explosive mixture;

FIG. 2 illustrates a hardware configuration of a data processing system in accordance with an embodiment of the present invention;

FIG. 3 illustrates a hardware configuration of a centralized processing location in accordance with an embodiment of the present invention; and

FIGS. 4A-C are a flowchart of a method for detecting an explosive mixture based on identifying components of the explosive mixture in accordance with an embodiment of the present invention.

### DETAILED DESCRIPTION

The present invention comprises a method, system and computer program product for detecting an explosive mixture. In one embodiment of the present invention, a potentially hazardous material is embedded with molecules, such as by the manufacturer of the potentially hazardous material, where these molecules are used for identifying individual cells or nano-devices. Upon scanning the potentially hazardous material (e.g., the potentially hazardous material embedded with these molecules may be contained in a passenger's carry-on luggage which is scanned at the airport's baggage screening station), the embedded molecules act as tiny ID tags that use the presence of a chemical, or a mix of chemicals (e.g., potentially hazardous material), as inputs, and give off light or sonar signatures as output. The output of these molecules may be read by a reader which may be used to identify the type of material as well as the amount of the material. This information may be stored and correlated with the passenger carrying the identified material and the passenger's flight information. A security alert may be generated if there is a combination of other amounts of potentially hazardous materials previously identified along with the amount of potentially hazardous material currently identified that together would be classified as an explosive device where the amounts of potentially hazardous materials previously identified are being carried by individual(s) who are to board the same flight(s) as the passenger discussed above.

It is noted that even though the following discusses detecting an explosive mixture based on identifying components of the explosive mixture using molecular computational identification in connection with airport security that the principles of the present invention may be applied to other fields, such as nuclear plants, sports stadiums, subways, coal mines, etc. That is, the principles of the present invention may be applied to any field involving the detection of an explosive device that may be carried by multiple individuals, where each individual carries a component of the explosive device. It is further noted that a person of ordinary skill in the art would be capable of applying the principles of the present invention to any field involving the detection of an explosive device that may be carried by multiple individuals, where each individual carries a component of the explosive device. Further, embodiments covering such permutations would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

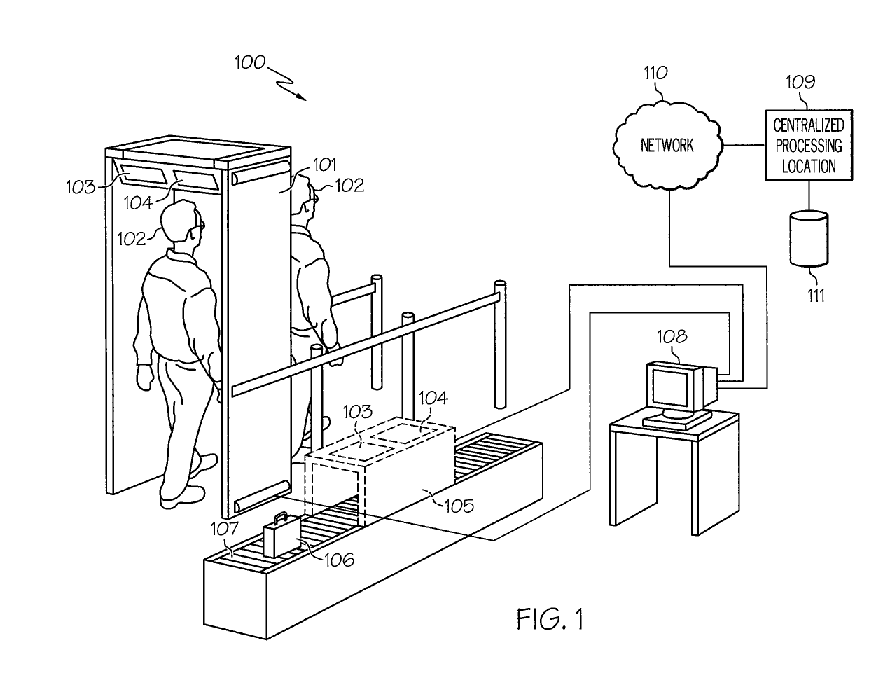

### FIG. 1—System for Detecting an Explosive Mixture

FIG. 1 illustrates an embodiment of a system 100 for detecting an explosive mixture in the context of airport security in accordance with the present invention. System 100 includes a detector 101 configured to scan airplane passengers 102 as airplane passengers 102 walk under detector 101. Detector 101 may be equipped with a scanner 103 and a reader 104 (referred to herein as the “molecular computational identification reader” or “MCID reader”) as discussed further below. System 100 may further include a luggage screening machine 105 configured to screen carry-on luggage 106 placed on a conveyor 107 by airplane passengers 102. Once airplane passenger 102 passes through detector 101 and there is no indication of carrying prohibited items or potentially hazardous materials, airplane passenger 102 may retrieve his/her carry-on luggage 106 assuming there is no indication that carry-on luggage 106 includes prohibited items or potentially hazardous materials. Luggage screening machine 105 may also include a scanner 103 and MCID reader 104. In one embodiment, MCID reader 104 may be a separate hand-held reader.

Potentially hazardous materials (e.g., semtex, which is a general-purpose plastic explosive) may be embedded with molecules used for identifying individual cells or nano-devices. A potentially hazardous material may refer to herein as any material that may or may not be hazardous by itself but can be used in connection with other materials to devise an explosive device. Embedding molecules used to identify individual cells or nano-devices may be referred to as “molecular computational identification.” Scanner 103 may be configured to emit light (e.g., photons) or neurons or any other means that causes the embedded molecules in a potentially hazardous material to emit light or sonar signatures based on the presence of a chemical, or a mix of chemicals. That is, these embedded molecules may act as tiny ID tags that use the presence of a chemical, or a mix of chemicals (e.g., potentially hazardous material), as inputs, and give off light or sonar signatures as output. The output of these molecules may be read by MCID reader 104 which may be used to identify the type of material as well as the amount of the material.

For example, suppose an airplane passenger 102 attempts to carry on board an airplane a potentially hazardous material, either on the body of airplane passenger 102 or in carry-on luggage 106, which unknowingly to airplane passenger 102 has been embedded with molecules as discussed above. As passenger 102 walks through detector 101 or as carry-on luggage 106 is screened by luggage screening machine 105, scanner 103 causes the embedded molecules to emit light or sonar signatures based on the presence of the potentially hazardous material which is detected by reader 104. The light or sonar signatures detected by reader 104 may be used to identify the type of material as well as the amount of the material.

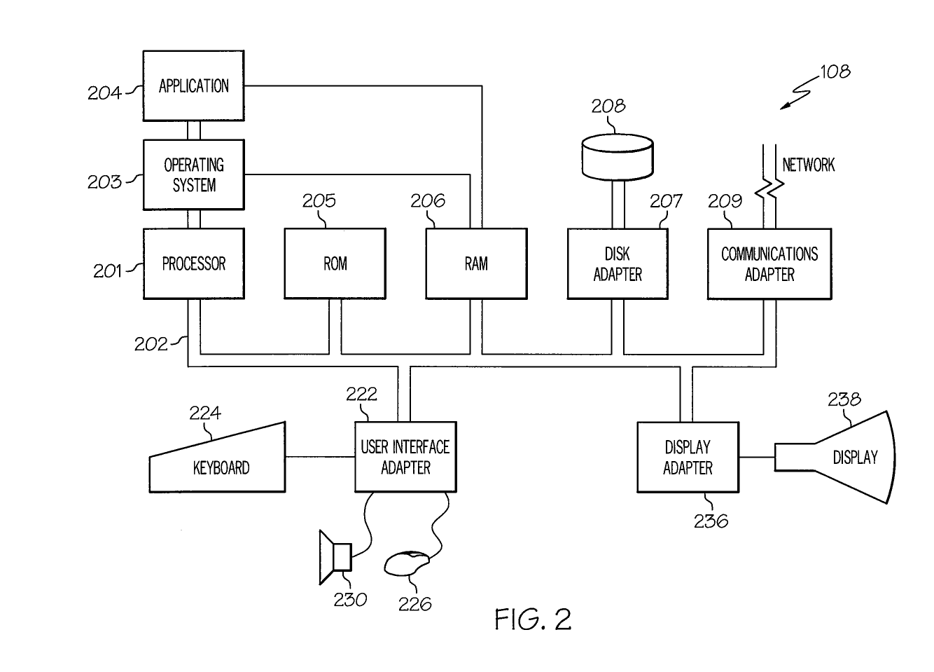

Referring to FIG. 1, system 100 further includes a data processing system 108 connected to detector 101, scanner 103, reader 104 and luggage screening machine 105. Data processing system 108 may reside in the security area, such as the area near detector 101 and luggage screening machine 105. A detail description of the hardware configuration of data processing system 108 is provided below in connection with FIG. 2.

Data processing system 108 may be connected to a centralized processing location (e.g., server) 109 via a network 110 (e.g., Local Area Network (LAN), such as Ethernet, Token Ring, ARCnet, or a Wide Area Network (WAN), such as the Internet). The connection between data processing system 108 and centralized processing location 109 may be any medium type (e.g., wireless, wired). Further, data processing system 108 may be any type of device (e.g., wireless, Personal Digital Assistant (PDA), cell phone, personal computer system, workstation, Internet appliance) configured with the capability of connecting to network 110 and consequently communicating with centralized processing location 109.

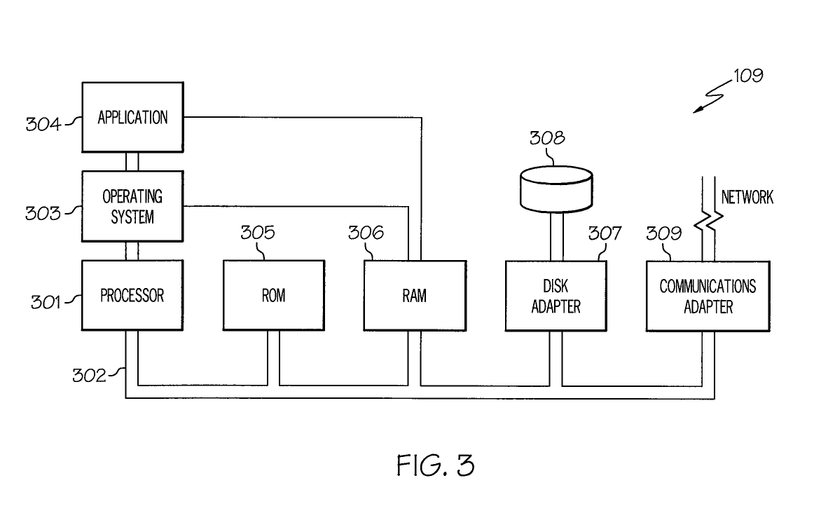

Centralized processing location 109 may be connected to a database 111 configured to store various information, such as profiles of potential terrorists, plane information (e.g., size of airplane), flight information (e.g., place of origination and destination of particular flight), potentially hazardous materials previously detected for each passenger and flight(s) of passenger, combination of ingredients to devise an explosive device as well as the particular amounts for each ingredient to devise such an explosive device for each type of airplane, etc. A detail description of the hardware configuration of centralized processing location 109 is provided further below in connection with FIG. 3.

Referring to FIG. 1, system 100 may include other components that were not depicted so as to not obscure the inventive principles of the present invention. System 100 is exemplary of practicing the present invention in connection with airport security. As discussed above, the principles of the present invention may be applied to any field involving the detection of an explosive device that may be carried by multiple individuals, where each individual carries a component of the explosive device. FIG. 1 is not to be limited in scope to any one particular embodiment.

### FIG. 2—Hardware Configuration of Data Processing System

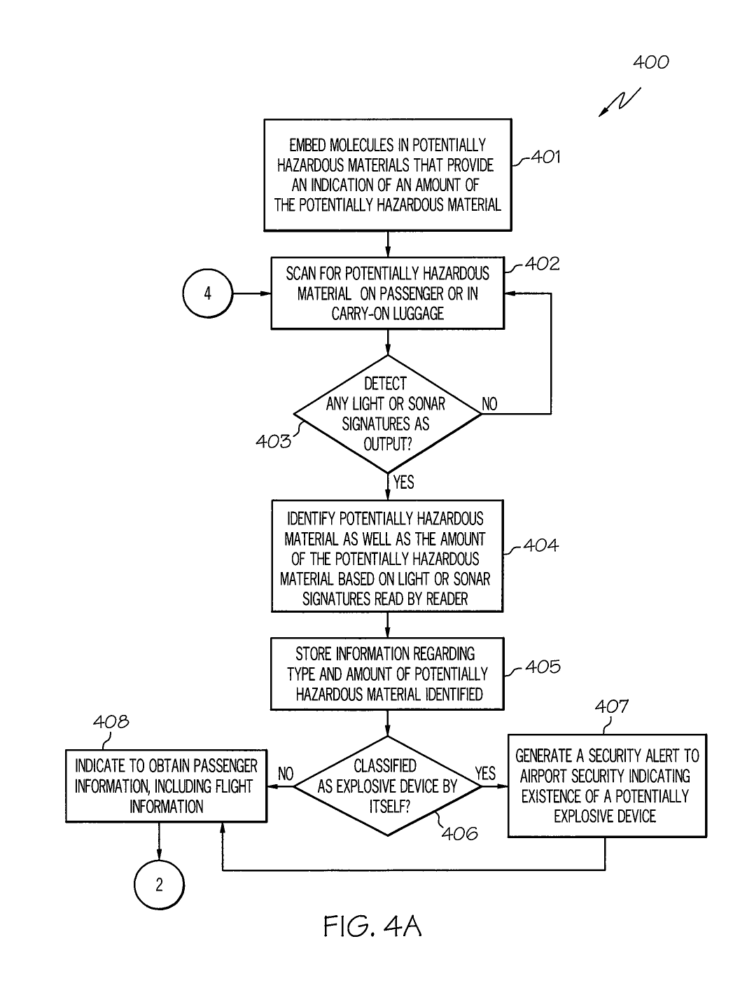

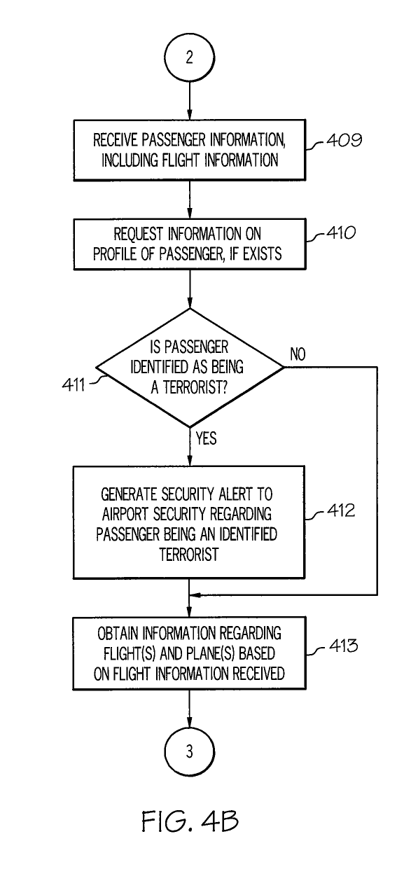

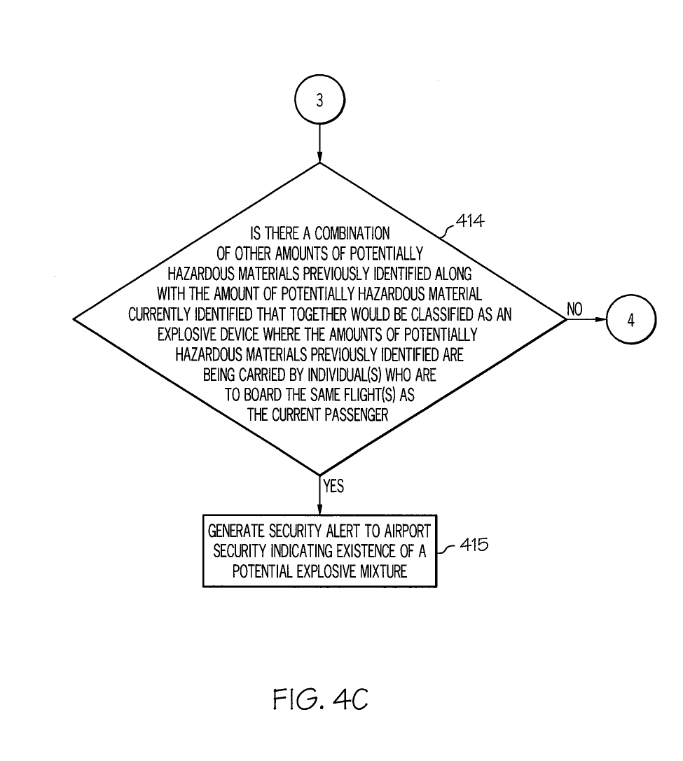

FIG. 2 illustrates an embodiment of a hardware configuration of data processing system 108 (FIG. 1) which is representative of a hardware environment for practicing the present invention. Data processing system 108 may have a processor 201 coupled to various other components by system bus 202. An operating system 203 may run on processor 201 and provide control and coordinate the functions of the various components of FIG. 2. An application 204 in accordance with the principles of the present invention may run in conjunction with operating system 203 and provide calls to operating system 203 where the calls implement the various functions or services to be performed by application 204. Application 204 may include, for example, a program for detecting an explosive mixture based on identifying components of the explosive mixture using molecular computational identification, as discussed below in association with FIGS. 4A-C.

Referring to FIG. 2, Read-Only Memory (ROM) 205 may be coupled to system bus 202 and include a basic input/output system (“BIOS”) that controls certain basic functions of data processing system 108. Random access memory (RAM) 206 and disk adapter 207 may also be coupled to system bus 202. It should be noted that software components including operating system 203 and application 204 may be loaded into RAM 206, which may be data processing system's 108 main memory for execution. Disk adapter 207 may be an integrated drive electronics (“IDE”) adapter that communicates with a disk unit 208, e.g., disk drive. It is noted that the program for detecting an explosive mixture based on identifying components of the explosive mixture using molecular computational identification, as discussed below in association with FIGS. 4A-C, may reside in either application 204 or in disk unit 208.

Referring to FIG. 2, data processing system 108 may further include a communications adapter 209 coupled to bus 202. Communications adapter 209 may interconnect bus 202 with network 110 enabling data processing system 108 to communicate with centralized processing location 109.

I/O devices may also be connected to data processing system 108 via a user interface adapter 222 and a display adapter 236. Keyboard 224, mouse 226 and speaker 230 may all be interconnected to bus 202 through user interface adapter 222. Data may be inputted to data processing system 108 through any of these devices. A display monitor 238 may be connected to system bus 202 by display adapter 236. In this manner, a user is capable of inputting to data processing system 108 through keyboard 224 or mouse 226 and receiving output from data processing system 108 via display 238 or speaker 230.

The various aspects, features, embodiments or implementations of the invention described herein can be used alone or in various combinations. The methods of the present invention can be implemented by software, hardware or a combination of hardware and software. The present invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

### FIG. 3—Hardware Configuration of Centralized Processing Location

FIG. 3 illustrates a typical hardware configuration of a centralized processing location 109 (FIG. 1) which is representative of a hardware environment for practicing the present invention. Centralized processing location 109 may have a processor 301 coupled to various other components by system bus 302. An operating system 303 may run on processor 301 and provide control and coordinate the functions of the various components of FIG. 3. An application 304 in accordance with the principles of the present invention may run in conjunction with operating system 303 and provide calls to operating system 303 where the calls implement the various functions or services to be performed by application 304. Application 304 may include, for example, a program for detecting an explosive mixture based on identifying components of the explosive mixture using molecular computational identification, as discussed below in association with FIGS. 4A-C.

Referring to FIG. 3, Read-Only Memory (ROM) 305 may be coupled to system bus 302 and include a basic input/output system (“BIOS”) that controls certain basic functions of centralized processing location 109. Random access memory (RAM) 306 and disk adapter 307 may also be coupled to system bus 302. It should be noted that software components including operating system 303 and application 304 may be loaded into RAM 306, which may be centralized processing location's 109 main memory for execution. Disk adapter 307 may be an integrated drive electronics (“IDE”) adapter that communicates with a disk unit 308, e.g., disk drive. It is noted that the program for detecting an explosive mixture based on identifying components of the explosive mixture using molecular computational identification, as discussed below in association with FIGS. 4A-C, may reside in either application 304 or in disk unit 308.

Referring to FIG. 3, centralized processing location 109 may further include a communications adapter 309 coupled to bus 302. Communications adapter 309 may interconnect bus 302 with a network 110 enabling centralized processing location 109 to communicate with data processing system 108.

The various aspects, features, embodiments or implementations of the invention described herein can be used alone or in various combinations. The methods of the present invention can be implemented by software, hardware or a combination of hardware and software. The present invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

As discussed in the Background Information section, currently, the focus of preventing an explosive device from detonating at a public place, such as on an airplane, is focused on detecting banned materials (e.g., semtex) or on biometrics and facial scanning to identify a potential terrorist. However, as discussed above in connection with the United Kingdom terror plot, many of the hazardous materials were planned to be carried in common articles, such as liquids and gels. Further, the common articles, such as liquids and gels, may not be identified as an explosive device as a single component but may be used in combination to form an explosive device. Currently, there is no mechanism in detecting an explosive device based on identifying the combination of materials of the explosive device that may be carried in common articles. Therefore, there is a need in the art for detecting an explosive mixture based on identifying components of the explosive mixture. A method for detecting an explosive mixture based on identifying components of the explosive mixture is discussed below in association with FIGS. 4A-C.

### FIGS. 4A-C—Method for Detecting an Explosive Mixture Based on Identifying Components of the Explosive Mixture

FIGS. 4A-C is a flowchart of a method 400 for detecting an explosive mixture based on identifying components of the explosive mixture in accordance with an embodiment of the present invention.

Referring to FIG. 4A, in conjunction with FIGS. 1-3, in step 401, molecules are embedded by the manufacturers of materials deemed to be “potentially hazardous” in accordance with molecular computational identification as discussed above. These molecules are configured to output light or sonar signatures upon being scanned if the material includes the presence of chemical, or a mix of chemicals, deemed to be potentially hazardous.

In step 402, scanner 103 of detector 101, luggage screening machine 105 scans for a potentially hazardous material. For example, scanner 103 in detector 101 may scan an airplane passenger 102, including all materials carried by airplane passenger 102, such as when airplane passenger 102 passes through detector 101 prior to boarding an airplane flight. In another example, scanner 103 in luggage screening machine 105 scans for potentially hazardous materials being stowed in carry-on luggage 106.

In step 403, reader 104 of detector 101, luggage screening machine 105 determines whether there is any light or sonar outputted by material scanned. Upon scanning for a potentially hazardous material by scanner 103, reader 104 detects any light or sonar signatures outputted by material scanned.

If there is no light or sonar signatures detected by reader 104, then, in step 402, scanner 103 of detector 101, luggage screening machine 105 scans for a potentially hazardous material carried by another passenger either on himself/herself or in the passenger's carry-on luggage 106.

If, however, there is light or sonar signatures detected by reader 104, in step 404, data processing system 108 or centralized processing location 109 identify a potentially hazardous material as well as an amount of the potentially hazardous material based on the light or sonar signatures detected by reader 104. Either data processing system 108 or centralized processing location 109 may contain software configured to identify a potentially hazardous material as well as an amount of the potentially hazardous material based on the light or sonar signatures detected by reader 104. If centralized processing location 109 identifies the potentially hazardous material as well as determines the amount of the potentially hazardous material based on the light or sonar signatures detected by reader 104, data processing system 108 may be configured to forward the information read by reader 104 to centralized processing location 109.

In step 405, data processing system 108 or centralized processing location 109 stores, such as in database 111, the type and amount of potentially hazardous material identified. If data processing system 108 determines the type and amount of potentially hazardous material based on the light or sonar signatures detected by reader 104, then data processing system 108 may store this information on database 111 via centralized processing location 109. Alternatively, if centralized processing location 109 determines the type and amount of potentially hazardous material based on the light or sonar signatures detected by reader 104, then centralized processing system 109 may store this information on database 111.

In step 406, data processing system 108 or centralized processing location 109 determines whether the type of and amount of potentially hazardous material identified is classified as an explosive device by itself.

If processing system 108 or centralized processing location 109 determines that the type of and amount of potentially hazardous material identified is classified as an explosive device by itself, then, in step 407, data processing system 108 or centralized processing location 109 generates a security alert to airport security indicating the existence of a potentially explosive device.

Upon generating a security alert, or, if the type of and amount of potentially hazardous material identified is not classified as an explosive device by itself, then, in step 408, data processing system 108 or centralized processing location 109 indicates to obtain passenger information, including flight information. For example, data processing system 108 may indicate to a security personnel in the security area to stop the passenger carrying a material (either on himself/herself or in carry-on luggage 106) determined to be potentially hazardous and obtain passenger information, such as a boarding pass and airplane tickets. A name may then be obtained for the passenger as well as the flight(s) the passenger is expected to take. In another example, centralized processing location 109 may indicate to security personnel in the security area to stop the passenger carrying a material (either on himself/herself or in carry-on luggage 106) determined to be potentially hazardous and obtain passenger information, such as a boarding pass and airplane tickets. The security personnel may be carrying a PDA which is contacted by centralized processing location 109 wirelessly to inform the security personnel to obtain passenger information from the passenger that just passed through detector 101.

Referring to FIG. 4B, in conjunction with FIGS. 1-3, in step 409, data processing system 108 or centralized processing location 109 receives the passenger, including flight information, from security personnel or from an individual from an organization (e.g., airline) that is able to obtain such information on the passenger carrying a detected potentially hazardous material.

In step 410, data processing system 108 or centralized processing location 109 requests from database 111 information on the profile of the passenger carrying the detected potentially hazardous material, if there exists such a profile. Data processing system 108 or centralized processing location 109 may provide information, such as a name, to database 111 to determine if there is a profile for this passenger.

In step 411, data processing system 108 or centralized processing location 109 determines whether or not the passenger carrying the detected potentially hazardous material is identified as being a terrorist. For example, database 111 may provide a profile on the passenger carrying the detected potentially hazardous material which includes a terrorist warning.

If data processing system 108 or centralized processing location 109 determines that the passenger carrying the detected potentially hazardous material is a terrorist, then, in step 412, data processing system 108 or centralized processing location 109 generate a security alert to airport security regarding the passenger being identified as a terrorist.

Upon the execution of step 412, or if data processing system 108 or centralized processing location 109 did not determine that the passenger carrying the detected potentially hazardous material was a terrorist, then, in step 413, data processing system 108 or centralized processing location 109 obtains information regarding the flight(s) or plane(s) based on the flight information received. For example, data processing system 108 or centralized processing location 109 may obtain, in step 409, the flight information of the passenger carrying the detected potentially hazardous material where the flight information includes the place of origination and the place of destination as well as all intervening flights as well as the type of airplanes for each flight. In one embodiment, data processing system 108 or centralized processing location 109 obtains this information from database 111. The information regarding the flights and airplanes may be valuable information in order to determine whether there is a potential explosive mixture based on other types and amounts of potentially hazardous materials identified as being carried by individuals on these flights and airplanes. The type of airplane may be important as the size and amount of fuel carried on the airplane may determine the amount required for each component of the explosive device in order to construct a workable explosive device.

Referring to FIG. 4C, in conjunction with FIGS. 1-3, in step 414, data processing system 108 or centralized processing location 109 determines whether there is a combination of other amounts of potentially hazardous materials previously detected along with the amount of potentially hazardous material identified in step 404 that together would be classified as an explosive device where the amounts of the potentially hazardous materials previously identified are being carried by individual(s) (either on himself/herself or in carry-on luggage 106) who are to board the same flight(s) as the passenger identified in step 408. As discussed above, this determination takes into consideration the type of airplane, such as the amount of fuel and the size of the aircraft.

For example, suppose that an explosive device can be classified as a solution containing the following elements and amounts: A (8 ml); D (7 ml); G (4 ml) and J (10 ml). Suppose further that (1): one hour before flight 1234 from Boston to Atlanta with a connecting flight 7777 to San Francisco, reader 104 detects a passenger carrying through airport security (either on himself/herself or in carry-on luggage 106) a solution containing 8 ml of component “A;” (2) half an hour before flight 1234 from Boston to Atlanta with a connecting flight 7777 to San Francisco, reader 104 detects a passenger carrying through airport security a solution containing 4 ml of component “G;” (3) in Baltimore, flight 2468 to Atlanta with a connecting flight 7777 to San Francisco, reader 104 detects a passenger carrying through airport security a solution containing 7 ml of component “D;” half an hour before flight 7777 from Atlanta to San Francisco, reader 104 detects a passenger carrying through airport security a solution containing 10 ml of component “J.” The readings from the networked remote readers 104 may be collated, cross-checked and processed thereby identifying a composition of an explosive mixture, namely, A (8 ml); D (7 ml); G (4 ml) and J (10 ml). Hence, the existence of a potential explosive mixture has been detected for flight 7777.

If a potential explosive mixture has been detected, then, in step 415, data processing system 108 or centralized processing location 109 generates a security alert to airport security indicating the existence of a potential explosive mixture.

In one embodiment, different levels of a security alert could be generated based on how close an explosive device could be made based on the detected potentially hazardous materials. Referring to the above example, if 8 ml of component “A” and 4 ml of component “G” where identified, then, a low level notification may be generated to officials indicating a possibility that a group of individuals may be attempting to devise an explosive device since 2 out of the 4 components to devise the explosive device have been detected.

If, however, a potential explosive mixture has not been detected, then, in step 402, scanner 103 of detector 101, luggage screening machine 105 scans for a potentially hazardous material carried by another passenger either on himself/herself or in the passenger's carry-on luggage 106.

Method 400 may include other and/or additional steps that, for clarity, are not depicted. Further, method 400 may be executed in a different order presented and that the order presented in the discussion of FIGS. 4A-C is illustrative. Additionally, certain steps in method 400 may be executed in a substantially simultaneous manner or may be omitted.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for detecting an explosive mixture comprising the steps of:
scanning a potentially hazardous material embedded with molecules used for identifying individual cells, wherein said molecules generate one of light and sonar signatures based on said scanning;
detecting one of said light and sonar signatures generated based on said scanning;
identifying an amount of said potentially hazardous material based on detecting one of said light and sonar signatures; and
generating a security alert indicating existence of a potentially explosive mixture if there exists a combination of other amounts of potentially hazardous materials previously identified with said identified amount of said potentially hazardous material.

2. The method as recited in claim 1 further comprising the step of:
storing said amount identified of said potentially hazardous material.

3. The method as recited in claim 2 further comprising the step of:
indicating to obtain passenger information, including flight information, of passenger carrying said potentially hazardous material.

4. The method as recited in claim 3 further comprising the step of:
receiving passenger information, including flight information, of said passenger carrying said potentially hazardous material.

5. The method as recited in claim 3 further comprising the step of:
requesting information on a profile of said passenger carrying said potentially hazardous material.

6. The method as recited in claim 5 further comprising the step of:
generating a security alert to airport security if said passenger is identified as being a terrorist.

7. The method as recited in claim 3 further comprising the step of:
obtaining information regarding flight and plane based on said flight information.

8. The method as recited in claim 7 further comprising the step of:
generating a security alert to airport security indicating existence of a potentially explosive mixture if there exists a combination of other amounts of potentially hazardous materials previously detected for a flight of said passenger along with said identified amount of said potentially hazardous material.

9. The method as recited in claim 1 further comprising the step of:
generating a security alert to airport security indicating existence of a potentially explosive device based on amount identified of said potentially hazardous material.

10. A system, comprising:
a scanner configured to scan a potentially hazardous material embedded with molecules used for identifying individual cells, wherein said molecules generate one of light and sonar signatures based on scanning by said scanner;
a reader coupled said scanner, wherein said reader is configured to detect one of said light and sonar signatures generated based on said scanning; and
a computer coupled to said scanner and said reader, wherein said computer comprises:
a memory unit for storing a computer program for detecting an explosive mixture;
a processor coupled to said memory unit, wherein said processor, responsive to said computer program, comprises:
circuitry for identifying an amount of said potentially hazardous material based on detecting one of said light and sonar signatures; and
circuitry for generating a security alert indicating existence of a potentially explosive mixture if there exists a combination of other amounts of potentially hazardous materials previously identified with said identified amount of said potentially hazardous material.

11. The system as recited in claim 10, wherein said processor further comprises:
circuitry for storing said amount identified of said potentially hazardous material.

12. The system as recited in claim 11, wherein said processor further comprises:
circuitry for indicating to obtain passenger information, including flight information, of passenger carrying said potentially hazardous material.

13. The system as recited in claim 12, wherein said processor further comprises:
circuitry for receiving passenger information, including flight information, of said passenger carrying said potentially hazardous material.

14. The system as recited in claim 12, wherein said processor further comprises:
circuitry for requesting information on a profile of said passenger carrying said potentially hazardous material.

15. The system as recited in claim 14, wherein said processor further comprises:
circuitry for generating a security alert to airport security if said passenger is identified as being a terrorist.

16. The system as recited in claim 12, wherein said processor further comprises:
circuitry for obtaining information regarding flight and plane based on said flight information.

17. The system as recited in claim 16, wherein said processor further comprises:
circuitry for generating a security alert to airport security indicating existence of a potentially explosive mixture if there exists a combination of other amounts of potentially hazardous materials previously detected for a flight of said passenger along with said identified amount of said potentially hazardous material.

18. The system as recited in claim 10, wherein said processor further comprises:
circuitry for generating a security alert to airport security indicating existence of a potentially explosive device based on amount identified of said potentially hazardous material.

19. A computer program product embodied in a computer readable medium for detecting an explosive mixture comprising the programming steps of:
identifying an amount of a potentially hazardous material based on detecting one of light and sonar signatures generated based on scanning said potentially hazardous material, wherein said potentially hazardous material is embedded with molecules used for identifying individual cells, wherein said molecules generate one of said light and sonar signatures based on said scanning; and
generating a security alert indicating existence of a potentially explosive mixture if there exists a combination of other amounts of potentially hazardous materials previously identified with said identified amount of said potentially hazardous material.

20. The computer program product as recited in claim 19 further comprising the programming step of:
storing said amount identified of said potentially hazardous material.

21. The computer program product as recited in claim 20 further comprising the programming step of:
indicating to obtain passenger information, including flight information, of passenger carrying said potentially hazardous material.

22. The computer program product as recited in claim 21 further comprising the programming step of:
receiving passenger information, including flight information, of said passenger carrying said potentially hazardous material.

23. The computer program product as recited in claim 21 further comprising the programming step of:
requesting information on a profile of said passenger carrying said potentially hazardous material.

24. The computer program product as recited in claim 23 further comprising the programming step of:
generating a security alert to airport security if said passenger is identified as being a terrorist.

25. The computer program product as recited in claim 21 further comprising the programming step of:
obtaining information regarding flight and plane based on said flight information.

26. The computer program product as recited in claim 25 further comprising the programming step of:
generating a security alert to airport security indicating existence of a potentially explosive mixture if there exists a combination of other amounts of potentially hazardous materials previously detected for a flight of said passenger along with said identified amount of said potentially hazardous material.

27. The computer program product as recited in claim 19 further comprising the programming step of:
generating a security alert to airport security indicating existence of a potentially explosive device based on amount identified of said potentially hazardous material.
